(19) United States
(12) Patent Application Publication
(10) Pub. No.: US 2010/0107116 A1
(43) Pub. Date: Apr. 29, 2010

(54) INPUT ON TOUCH USER INTERFACES

(75) Inventors: John Rieman, Helsinki (FI); Kari Hiitola, Tampere (FI); Harri Heine, Tampere (FI); Jyrki Yli-Nokari, Saratoga, CA (US); Markus Kallio, Espoo (FI); Mika Kaki, Tampere (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/258,978

(22) Filed: Oct. 27, 2008

(51) Int. Cl. G06F 3/048; G06F 3/041; G06F 3/033

(52) U.S. Cl. 715/784; 345/173; 715/863

(57) ABSTRACT

A user interface for use with a device having a display and a controller, the display being configured to display a portion of content, the content being related to an application which application the controller is configured to execute and the content including an object, the controller being further configured to receive touch input and determine whether the received touch input represents a scrolling action or an object specific action according to an originating location of the touch input in relation to the content.

### BACKGROUND

1. Field

The present application relates to a user interface, a device and a method for improved differentiating of input, and in particular to a user interface, a device and a method for differentiating between scrolling and object specific actions in touch-based user interfaces.

2. Brief Description of Related Developments

Contemporary small display devices with touch user interfaces usually have fewer user input controls than traditional Windows Icon Menu Pointer (WIMP) interfaces have, but they still need to offer a similar set of responses to user actions i.e. command and control possibilities.

A traditional WIMP (windows icons menus pointer) device may offer a mouse pointer, a left and right mouse button, a scroll wheel, keyboard scroll keys, and keyboard modifiers for mouse-clicks (e.g. control-left-mouse). A touch device relies entirely on touch on the screen with one or two fingers to send commands to the system, even where the underlying touch system is similar to the WIMP system and requires similar control information.

Also, a large screen device can easily offer scroll bars and other controls that require accurate pointing with a mouse cursor. On the small display, the space for scroll bars may be needed for content, and accurate pointing with a finger may be difficult.

This problem becomes especially apparent when the user is scrolling, panning, zooming, or rotating a web page, and the page includes embedded elements which are, themselves, sensitive to touch. In the following “panning” will be used to describe a translation of the content of an embedded object in relation the adjacent content and scrolling will be used to describe a translation of the whole content relative the application area.

For example, a page may contain a map which can be panned (moved), zoomed, or rotated within its frame on the web page. The panning would be done by dragging the map with a finger, and zooming would be done by pinching with two fingers. The page itself may also be panned or zoomed (and perhaps rotated) within the device window, again by dragging it or pinching it with finger(s). If the page has virtual momentum, it might be “flicked” so it begins to move and continues to move after the finger is removed, gradually slowing to a stop.

If the user has flicked the page and it has stopped moving with only the embedded element visible, then touching with the finger(s) will act on the element within the page. It will not scroll, pan, zoom, or rotate the page itself. And herein lays the problem of differentiating between an input for panning the embedded image and a scroll command for scrolling the whole page and to do this in a manner that is intuitive to both use and learn and which is also simple to use and to allow the user to maintain control over the page even without scrollbars.

### SUMMARY

On this background, it would be advantageous to provide a user interface, a device, a computer readable medium and a method that overcomes or at least reduces the drawbacks indicated above.

Further aspects, features, advantages and properties of a user interface, a device, a method and a computer readable medium according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIG. 1 is an overview of a telecommunications system in which a device according to the present application is used according to an embodiment,

FIG. 2 is a plane front view of a device according to an embodiment,

FIG. 3 is a block diagram illustrating the general architecture of a device of FIG. 2 in accordance with the present application,

FIG. 4 is a schematic view of content to be handled according to an embodiment,

FIGS. 5a, b, c and d are schematic views of an application area to be handled according to an embodiment,

FIG. 6 is a flow chart describing a method according to an embodiment,

FIGS. 7a, b and c are schematic views of content and an application area to be handled according to an embodiment,

FIG. 8 is a flow chart describing a method according to an embodiment,

FIGS. 9a, b, c and d are schematic views of content and an application area to be handled according to an embodiment,

FIG. 10 is a flow chart describing a method according to an embodiment,

FIGS. 11a, b, c and d are screen shots according to an embodiment, and

FIG. 12 is a flow chart describing a method according to an embodiment of the application.

### DETAILED DESCRIPTION OF THE DRAWINGS

In the following detailed description, the device, the method and the software product according to the teachings for this application in the form of a cellular/mobile phone will be described by the embodiments. It should be noted that although only a mobile phone is described the teachings of this application can also be used in any electronic device such as in portable electronic devices such as laptops, PDAs, mobile communication terminals, electronic books and notepads and other electronic devices offering access to information.

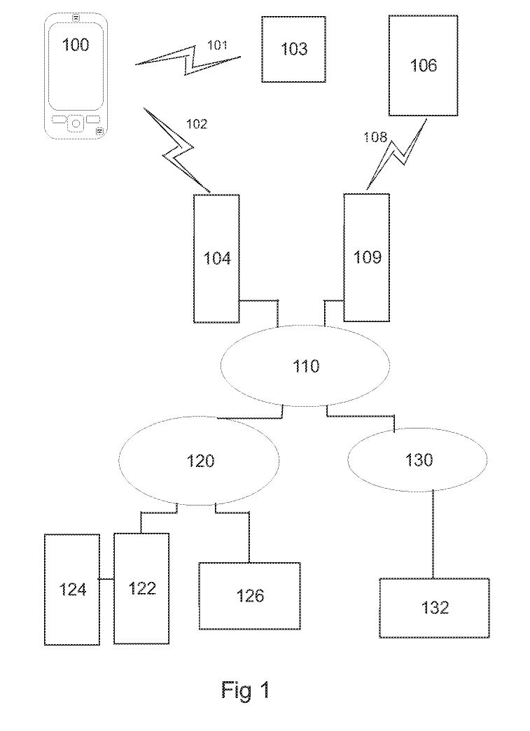

FIG. 1 illustrates an example of a cellular telecommunications system in which the teachings of the present application may be applied. In the telecommunication system of FIG. 1, various telecommunications services such as cellular voice calls, www or Wireless Application Protocol (WAP) browsing, cellular video calls, data calls, facsimile transmissions, music transmissions, still image transmissions, video transmissions, electronic message transmissions and electronic commerce may be performed between a mobile terminal 100 according to the teachings of the present application and other devices, such as another mobile terminal 106 or a stationary telephone 132. It is to be noted that for different embodiments of the mobile terminal 100 and in different situations, different ones of the telecommunications services referred to above may or may not be available; the teachings of the present application are not limited to any particular set of services in this respect.

The mobile terminals 100, 106 are connected to a mobile telecommunications network 110 through Radio Frequency, RF links 102, 108 via base stations 104, 109. The mobile telecommunications network 110 may be in compliance with any commercially available mobile telecommunications standard, such as Group Spéciale Mobile, GSM, Universal Mobile Telecommunications System, UMTS, Digital Advanced Mobile Phone system, D-AMPS, The code division multiple access standards CDMA and CDMA2000, Freedom Of Mobile Access, FOMA, and Time Division-Synchronous Code Division Multiple Access, TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, a Radio Standard link for example an RS-232 serial link, etc. The local devices 103 can for example be various sensors that can communicate measurement values to the mobile terminal 100 over the local link 101.

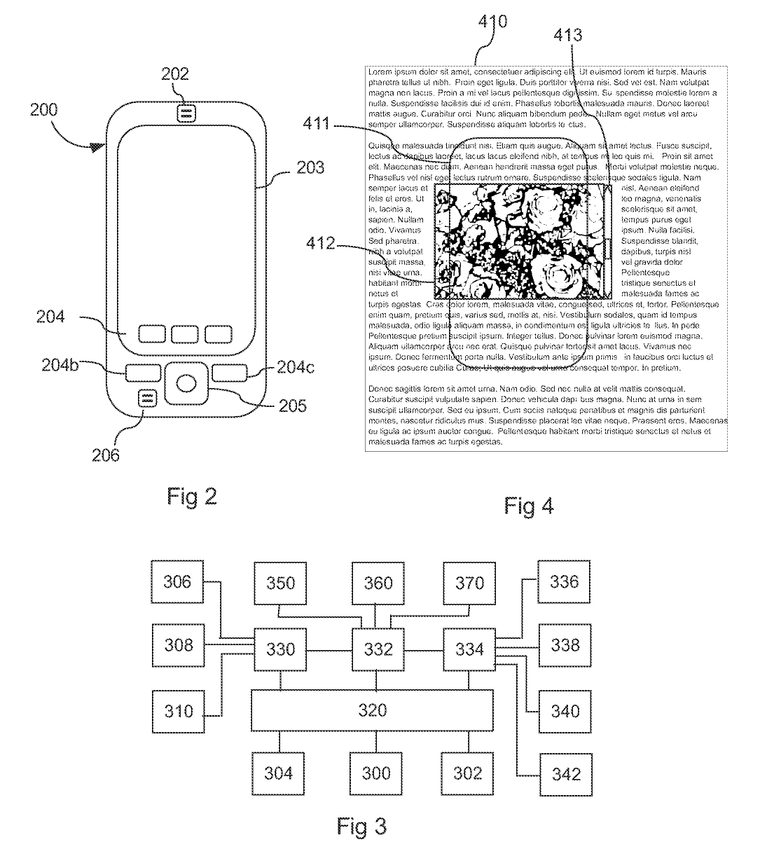

An embodiment 200 of the mobile terminal 100 is illustrated in more detail in FIG. 2. The mobile terminal 200 comprises a speaker or earphone 202, a microphone 206, a main or first display 203 being a touch display. As is commonly known a touch display may be arranged with virtual keys 204. The device is further arranged in this embodiment with a set of hardware keys such as soft keys 204b, 204c and a joystick 205 or other type of navigational input device.

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as Random Access Memory (RAM) memory, Read Only memory (ROM) memory, Electrically Erasable Programmable Read-Only Memory (EEPROM) memory, flash memory, or any combination thereof. The memory 302 is used for various purposes by the controller 300, one of them being for storing data used by and program instructions for various software in the mobile terminal. The software includes a real-time operating system 320, drivers for a man-machine interface (MMI) 334, an application handler 332 as well as various applications. The applications can include a message text editor 350, a notepad application 360, as well as various other applications 370, such as applications for voice calling, video calling, sending and receiving Short Message Service (SMS) messages, Multimedia Message Service (MMS) messages or email, web browsing, an instant messaging application, a phone book application, a calendar application, a control panel application, a camera application, one or more video games, a notepad application, etc. It should be noted that two or more of the applications listed above may be executed as the same application

The MMI 334 also includes one or more hardware controllers, which together with the MMI drivers cooperate with the touch display 336/203, and the keys 338/204, 205 as well as various other Input/Output devices such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, band pass filters, amplifiers, mixers, local oscillators, low pass filters, Analog to Digital and Digital to Analog (AD/DA) converters, etc.

FIG. 4 shows a schematic view of a content 410 to be displayed, which content is related to an application for example a page that has been downloaded from an internet web site. In this example the content consist of a text and an embedded object 412, which in this case is an image. The content in a specific zoom level and resolution takes up more space than is available on a display or an application area. It should be understood that in one embodiment the application area may take up the whole display or the whole portion of the display that is dedicated to show application data. It should be noted that the content displayed in the application area is only a portion of the full content to be displayed. In one embodiment the application area is smaller than the whole display and is related to a window for an application.

As can be seen in the figure the application area 411 is much smaller than the content 410 to be displayed and even narrower than the embedded object 412. In some applications, for example map applications on the internet, the embedded object is allocated to a certain fixed area of the web page and is scrollable within this area as is indicated by the scrollbar 413. In conventional systems it has been difficult to provide a user with simple and intuitive commands to scroll and to pan the content displayed. In the following the term scrolling will be used to describe an action where the entire content 410 is translated with regards to the application area 411 and the term panning will be used to describe an action where an embedded object 412 is translated with regards to the content 410 to be displayed. The similarity between these two actions can lead to difficulties for a controller or a user interface designer to differentiate between them. For example, if a user touches in the middle of the embedded object and performs a sliding gesture, is this to be understood as a scrolling action or a panning action? The question becomes even more relevant when a user scrolls through a large content 410 and happens to touch upon an embedded object 412.

To differentiate touch input representing a scrolling command from touch input representing a command for panning of an embedded object various techniques, as discussed below, can be used. The key issue to all these techniques is that they are intuitive to use and learn and that they are simple, easy and fast to use.

The techniques provide the differentiation in that they vary the touch input required slightly to make use of the realization that scrolling and panning are similar activities and so the commands should be similar but yet distinctive.

It should be noted that the problem of differentiating between a scrolling and a panning action is similar to the problem of differentiating between a scrolling and a dragging/moving action and all embodiments disclosed herein find use for both differentiating between panning and scrolling and scrolling and dragging.

It should also be noted that the problem of differentiating between whether a single object should be moved or panned and whether the full content should be scrolled is also similar to the problems above and the solutions provided below are also suited for solving this problem.

It should also be noted that even though the application is focused around panning and dragging actions it should be understood that the teachings herein can be implemented for differentiating between a scrolling (or panning) command and any object specific command. In the examples given the object specific commands are panning actions and dragging actions. Other examples of object specific commands related to gestures can be rotations, zooming, drawings, editing (possibly for text such as deleting strokes), stroke input (possibly for text input), and many more as are commonly known.

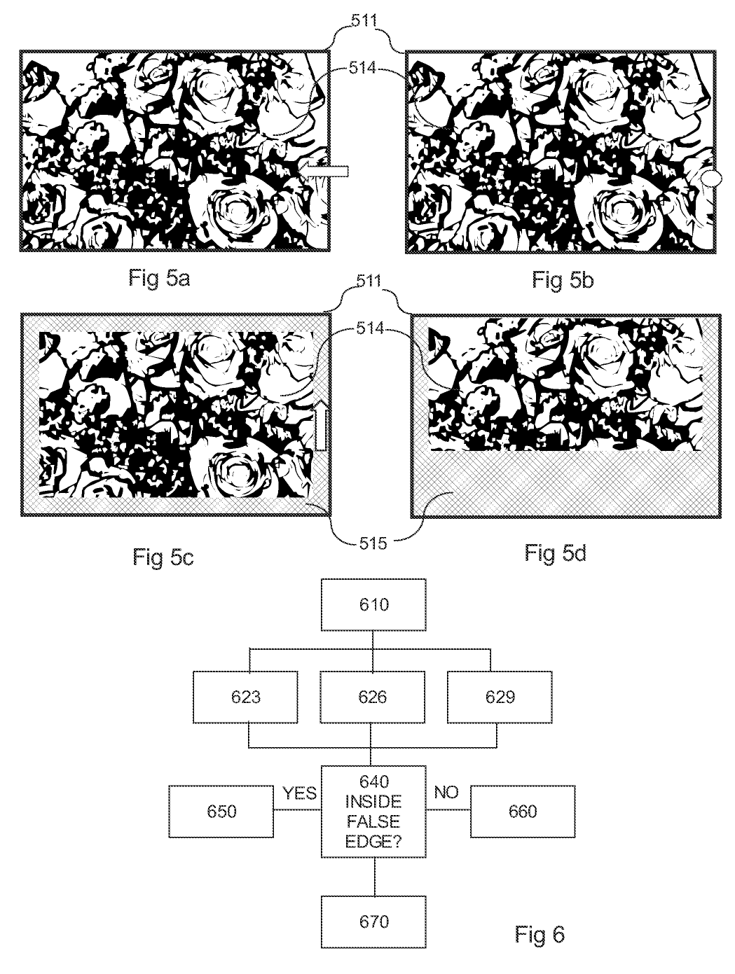

FIG. 5a shows a screen shot of an application area 511 being displayed on a display (203) of a device (200) according to an embodiment of the teachings herein which device in this embodiment is a mobile telephone but it should be understood that this application is not limited to mobile phones, but can find use in other devices having a touch based user interface such as personal digital assistants (PDA), laptops, media players, navigational devices, game consoles, personal organizers and digital cameras.

In this example the application area 511 currently displays a displayed portion 514 of a full content (410) which in this case is an embedded object (412) (or a portion thereof) similar to what has been described with reference to FIG. 4. As can be seen the embedded object (412) fills the whole application area 511.

One embodiment is shown in FIG. 5a where a user initiates an action by pressing near an edge of the application area 511 (indicated by the dot). This causes a controller to display a false edge 515 around the displayed content 514.

In this embodiment a controller is configured to interpret all touch and sliding gestures received within the application area as panning actions of the embedded object and any touch and sliding gesture which start in a false edge as a scrolling action of the entire content (410). To maximize the area available to show the embedded object the false edge is hidden in one embodiment and only visible upon activation.

One alternative embodiment is shown in FIG. 5b where a user starts an action by touching outside the application area 511 and moves into it (indicated by the arrow). This causes the controller to display the false edge around the displayed content. This embodiment is best suited for implementations where the application area does not take up the whole display area.

In an alternative embodiment (not shown) the false edge is shown as a touch input representing a panning action (a touch and a sliding gesture in the embedded object) is received.

As can be seen in FIG. 5c a touch and sliding gesture (indicated by the arrow) which is initiated in the false edge 515 is interpreted by the controller as a scrolling action resulting in that the whole content (410) is translated relative the application area 511 as seen in FIG. 5d. In one embodiment the false edge 515 is of a fixed size. Alternatively it is changed to indicate the original area displayed in the application area 511 as is shown in FIG. 5d. In one embodiment the false edge follows the movement of the touch input.

In one embodiment the false edge is transparent and in one embodiment the false edge is marked by a dashed or colored line. In the embodiment showed the false edge 515 is shadowed.

In an embodiment the false edge 515 is arranged along an edge of the application area 511. In an alternative embodiment the false edge 515 is arranged around the application area 511.

FIG. 6 shows a flowchart of a method according to an embodiment. The method is adapted to perform the steps discussed above in relation to the device.

In an initial step 610 a portion of content related to an application is displayed in an application area wherein an embedded object fills the whole of the application area. In one of three alternative steps, 623, 626 and 629, a touch input is received indicating that the false edge should be displayed. Step 623 corresponds to that the application area is touched near an edge. Step 626 corresponds to that a user touches outside the application area and continues the gesture inside the application area. And step 629 corresponds to that a panning action is initiated by touching and sliding inside the embedded object. It should be noted that a controller can be configured to accept all three of the alternatives, only one of them or any combination of them. In response to this a false edge is displayed in step 630 and any sliding input received (step 640) inside the false edge is interpreted as a scrolling action 650 and any sliding input received outside the false edge and inside the application area is interpreted as a panning action 660 and the display is updated accordingly, step 670.

In an embodiment where a draggable object instead of an embedded object is displayed the false edge would be arranged along the edges of the draggable object.

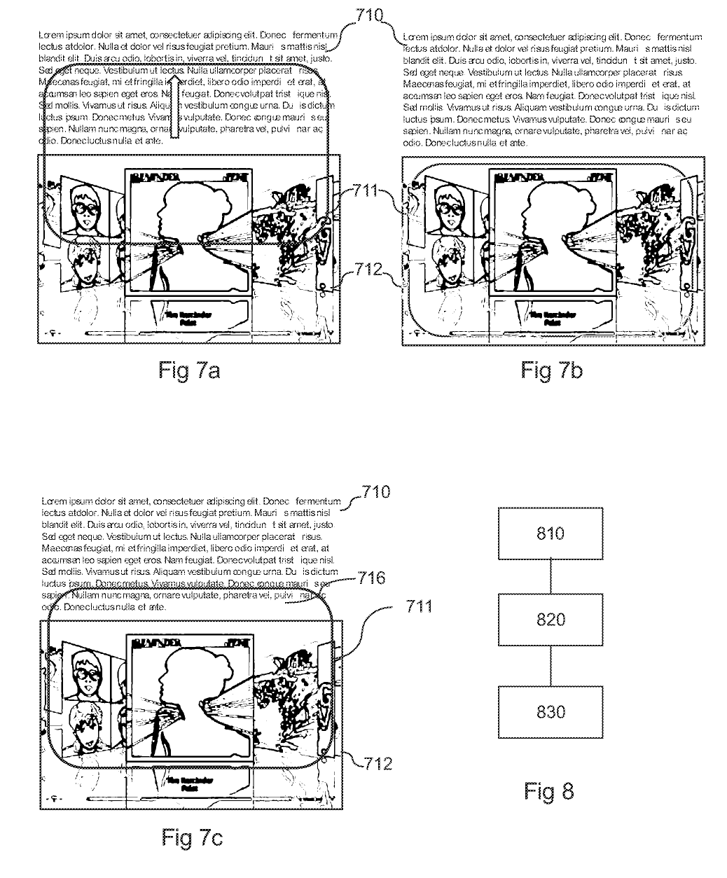

FIG. 7a shows a schematic view of content 710 related to an application being overlaid by an application area 711 to be displayed on a display (203) of a device (200) according to an embodiment of the teachings herein which device in this embodiment is a mobile telephone 700 but it should be understood that this application is not limited to mobile phones, but can find use in other devices having a touch based user interface such as personal digital assistants (PDA), laptops, media players, navigational devices, game consoles, personal organizers and digital cameras.

In one embodiment a controller is configured to receive touch input representing a scrolling action when the touch input is received within the general content 711 and representing a panning action when the touch input is received within an embedded object 712.

If the received touch input represents a scrolling action (indicated by the arrow) the controller is configured to translate the content 710 in relation to the application area 711. Should the scroll command result in that the scrolling is stopped so that only the embedded object 712 is displayed a user would not be able to input any scroll commands. See FIG. 7b.

In one embodiment the controller is configured to automatically scroll the content so that a portion of the content 711 is displayed should a user-initiated scroll command end in that only the embedded object 712 is displayed. The controller is thus configured to scroll the content 711 so that a portion 716 of the content 711 that is adjacent the embedded object 712 is displayed.

In one embodiment the portion 716 is the portion 716 that is before the embedded object 712 in the scrolling direction. In an alternative embodiment the portion 716 is the portion 716 that is after the embedded object 712 in the scrolling direction.

In one embodiment the content 710 is translated in the direction which is the shortest to an edge of said embedded object 712.

In one embodiment the controller is configured to scroll the content 712 smoothly after user input is no longer received. In an alternative embodiment the controller is configured to scroll the content 712 so that the portion 716 of the content 711 snaps into the application area 711 after user input is no longer received.

In one embodiment the controller is configured to execute the compensatory scroll as the touch input received is terminated and the touch pad or touch display through which the touch input is received is no longer in contact with the touching means, i.e. the finger, stylus or other means of interfacing with the touch display or touchpad used.

In one embodiment the controller is configured to prevent an embedded object 712 from fully occupying the application area 711 by automatically adjusting the application area's 711 position relative the full content 711.

FIG. 8 shows a flowchart of a method according to an embodiment. The method is adapted to perform the steps discussed above in relation to the device. In an initial step the controller receives touch input representing a scroll command and translates the content accordingly, step 810. Then the controller determines whether only an embedded object is displayed in an application area or not, step 820. If only an embedded object is displayed the controller compensates by automatically scrolling or translating the content so that a portion of the content adjacent to the embedded object is displayed, step 830.

In one embodiment step 820 and the resulting step 830 is performed simultaneously with step 810.

A similar scheme may be used for zooming actions. If a displayed content is zoomed so that an embedded object fills the whole screen or application area the controller could be configured to automatically zoom out so that a portion of the adjacent content is also displayed.

In one embodiment where a draggable object is displayed the controller is configured to automatically scroll so that the adjacent other content is also displayed in the application area.

In one embodiment the controller is configured to adapt the interpretation of the touch input depending on what is currently being displayed in the application area so that if touch input representing a scrolling action is received the content 710 is scrolled. If an embedded object 712 fully covers the application area 711 the touch input is re-determined to represent a panning action and the embedded object is panned until it reaches an end whereupon the controller is configured to re-determine the touch input as a scrolling action and continue scrolling the content 710. It should be understood that the embodiment works whether it is the same touch input that is being re-determined or if it is a new input that is determined accordingly.

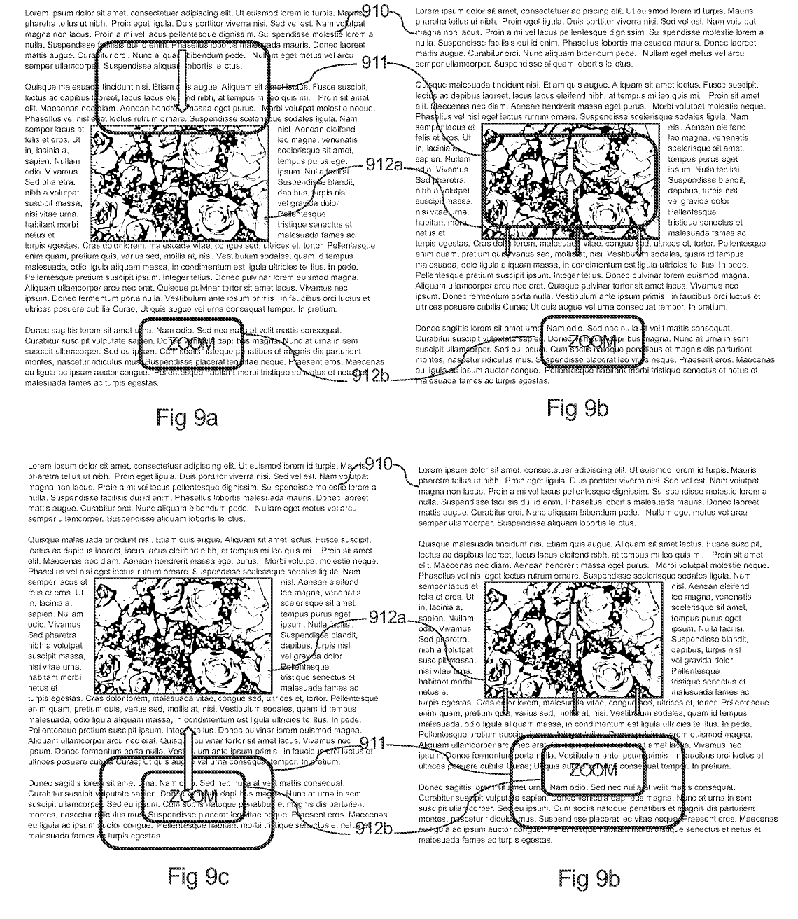

FIG. 9 shows a schematic view of content 910 related to an application being overlaid by an application area 911 to be displayed on a display (203) of a device (200) according to an embodiment of the teachings herein which device in this embodiment is a mobile telephone 900 but it should be understood that this application is not limited to mobile phones, but can find use in other devices having a touch based user interface such as personal digital assistants (PDA), laptops, media players, navigational devices, game consoles, personal organizers and digital cameras.

The content 911 in this example consist of text, an embedded object 912a and a draggable object 912b. In this example the embedded object 912a is an image and the draggable object 912b is a virtual magnifying glass.

A controller is configured to receive touch input and determine whether the received touch input represents a scrolling action, a panning action or a dragging action. The controller is configured to determine this based on both the originating location of the touch input and the action history, i.e. the actions taken just before the touch input was received.

In one embodiment the controller is configured to continue a scrolling action even after the touch input is generated. This provides a user the possibility of giving the scrolling action a virtual momentum so that the content can be accelerated and continues to scroll even after the sliding gesture has stopped. The same applies to panning actions in one embodiment.

In one embodiment the controller is configured to determine whether the received input is to be determined to be a scrolling action or a panning or dragging action depending on whether the earlier action was a scrolling action and whether the continued scrolling has stopped. If the scrolling is still ongoing the received touch input is determined to represent a further scrolling action. If the scrolling has stopped the received input is determined to represent a panning or dragging action.

In one embodiment the virtual momentum is proportional to the speed of the touch input. In one embodiment the virtual momentum is according to a preset time parameter.

In one embodiment the controller is configured to determine what the received touch input represents based on a timer. In this embodiment a scroll input sets a timer and all input received within that timer is to be interpreted as a scroll input. In one embodiment the timer is reset after each new scroll input.

An example is shown in FIG. 9. In FIG. 9a an application area 911 is currently showing a text portion of a content 910. A user performs a sliding gesture in the application area 911, indicated by the arrow, and the controller determines that the received input is a scrolling action as the touch input was received in the text portion and there are no earlier actions having been taken. The controller is thus configured to translate the content 910 with respect to the application area 911, see FIG. 9b.

In FIG. 9b the application area 911 is currently positioned directly over an embedded object 912a, in this example an image, as a new sliding gesture is received, indicated by the arrow A. Normally, user initiated touch input in an embedded object should pan the object, but in this example the scrolling action taken has been giving a momentum and is currently still scrolling as indicated by the arrows on the application area's 911 frame (i.e. the virtual momentum is greater than zero) and the controller thus determines that the received touch input represents a further scrolling action. And the controller is thus configured to translate the content 910 with respect to the application area 911, see FIG. 9c.

In FIG. 9c the application area 911 is located over the draggable object 912b and a further touch input is received, indicated by the arrow, in the form of a sliding gesture starting in the draggable object 912b and directed upwards. The controller determines that, as the previous scrolling command's virtual momentum is still in force (i.e. greater than zero) the received touch input is to be interpreted as representing a further scrolling action and the controller thus translates the content 910 in relation to the application area 911 upwards. See FIG. 9d.

In FIG. 9d the user has waited for the virtual momentum to die out. Alternatively the controller is configured to deplete the virtual momentum as touch input is received that represent a stopping action, i.e. holding the content still for a while. A further touch input has been received in the form of a sliding gesture originating in the draggable object 912b. The controller determined that as there was no more virtual momentum from the previous scrolling actions and that the touch input received originated in the draggable object 912b the controller was configured to relocate the draggable object according to the received touch input. In the figure it is now located over a text body which is to be enlarged for easier reading.

It should be noted that a combination of the virtual momentum and the timer and also that they are equivalent design options is to be understood as part of the teachings herein.

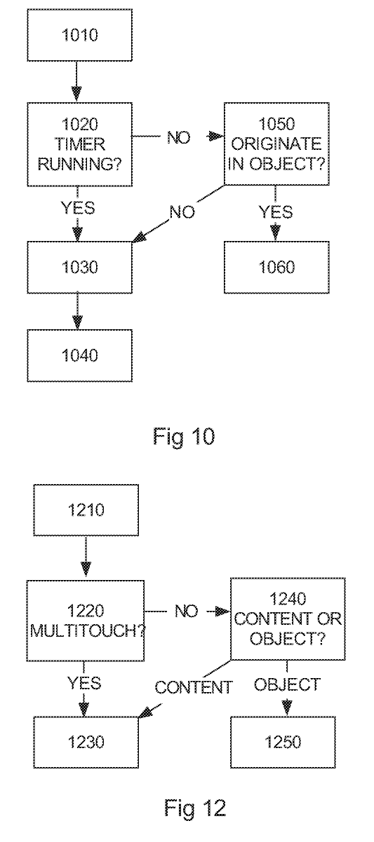

FIG. 10 shows a flowchart of a method according to an embodiment. The method is adapted to perform the steps discussed above in relation to the device.

In a first step 1010 a touch input in the form of a sliding gesture is received. A controller checks if a virtual momentum is still active or alternatively if timer is still running in step 1020. If so the touch input is determined to represent a scroll command and the controller executes the scroll command in step 1030 and the virtual momentum is re-calculated in step 1040. Alternatively the timer is reset. If the timer had lapsed or alternatively the virtual momentum was depleted (i.e. equal to zero) it is determined whether the sliding gesture originated within an embedded or draggable object in step 1050. If so the object is dragged or alternatively the embedded object is panned according to the touch input received in step 1060. If the touch input did not originate in neither an embedded object nor a draggable object the touch input is determined to represent a scroll command and the controller executes the scroll command in step 1030.

FIG. 11 shows screen shots of a display of a device according to an embodiment of the teachings herein which device in this embodiment is a mobile telephone 1100 but it should be understood that this application is not limited to mobile phones, but can find use in other devices having a touch based user interface such as personal digital assistants (PDA), laptops, media players, navigational devices, game consoles, personal organizers and digital cameras.

In FIG. 11a a display 1103 is currently displaying an application area 1111 for a meteorological application. In the application area 1111 two objects 1112a and 1112b are displayed, one 1112b showing a list of cities and one object 1112b showing a map of the country Finland. Alternatively the object 1112b represents the full content related to the application. In the following both objects are capable of being moved or dragged.

In FIG. 11b a user is providing touch input, indicated by the hand, which is received by a controller which is configured to determine that the touch input represents a drag or move command as it originates in the object 1112a which is capable of being dragged. The controller is configured to translate or drag the object 1112a in the direction of the arrow accordingly and update the display.

In FIG. 11c the user provides a multi-touch input in that two fingers are used to provide a sliding gesture that originates both in the draggable object 1112a and the other object 1112b. The controller is configured to interpret such a multi-touch gesture originating in more than one object as a scroll command for the whole page. The controller is configured to scroll the content in the direction of the arrow accordingly and update the display.

In FIG. 11d an alternative multi-touch input is provided by the user in that only one finger simultaneously touches more than one object 1112. The controller is configured, as for the example of FIG. 11c, to determine that such input gesture represents a scroll command and the controller is configured to scroll the content in the direction of the arrow accordingly and update the display.

It should be noted that the above also holds if the touch input simultaneously touches both an object 1112 and the underlying/adjacent content (410).

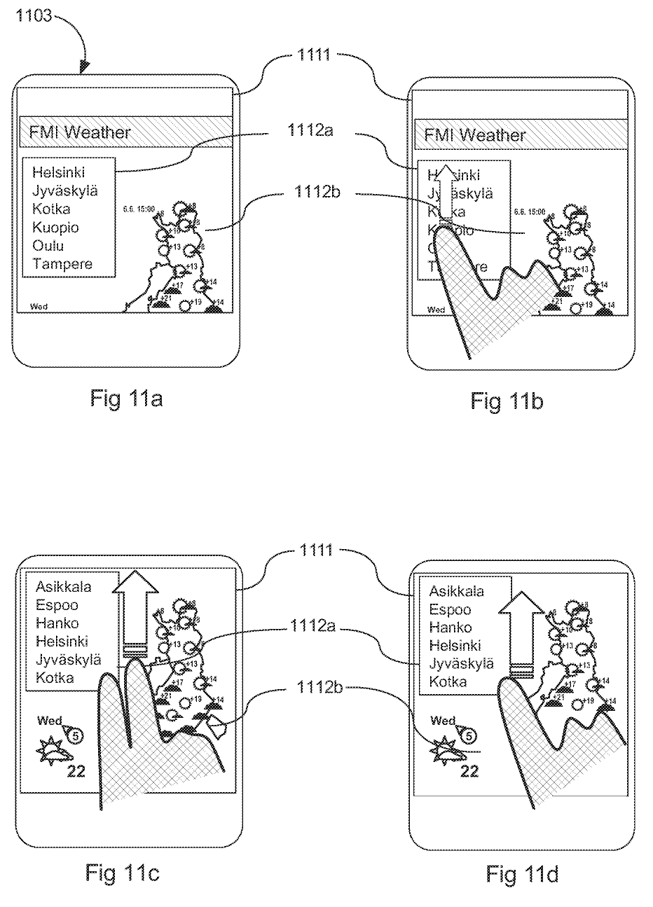

FIG. 12 shows a flowchart of a method according to an embodiment. The method is adapted to perform the steps discussed above in relation to the device.

In a first step 1210 touch input in the form of a sliding gesture is received. In a second step 1220 a controller determines whether the touch input is a multi-touch input or not identifying more than one object, alternatively identifying an object and the adjacent content. In an alternative embodiment the touch input means, for example the touch display, determines whether the touch input is multi-touch or not. If the received touch input is multi-touch the touch input is determined to represent a scroll command and the content is scrolled accordingly in step 1230. If the received touch input is determined not to be multi-touch the controller is configured to check in step 1240 whether the touch input received originates in an object or the surrounding/underlying content and depending on the origin determine the touch input to represent a scrolling command if the touch input originated in the content, step 1230, and to be a panning, dragging or object specific action if the touch input originated in an object, step 1250.

The various aspects of what is described above can be used alone or in various combinations. The teaching of this application may be implemented by a combination of hardware and software, but can also be implemented in hardware or software. The teaching of this application can also be embodied as computer readable code on a computer readable medium. It should be noted that the teaching of this application is not limited to the use in mobile communication terminals such as mobile phones, but can be equally well applied in Personal digital Assistants (PDAs), game consoles, MP3 players, personal organizers or any other device designed for providing a touch based user interface.

The teaching of the present application has numerous advantages. Different embodiments or implementations may yield one or more of the following advantages. It should be noted that this is not an exhaustive list and there may be other advantages which are not described herein. For example, one advantage of the teaching of this application is that a device is able to provide a user with a user interface capable of differentiating between the two similar inputs for the different actions.

Although the teaching of the present application has been described in detail for purpose of illustration, it is understood that such detail is solely for that purpose, and variations can be made therein by those skilled in the art without departing from the scope of the teaching of this application.

For example, although the teaching of the present application has been described in terms of a mobile phone, it should be appreciated that the teachings of the present application may also be applied to other types of electronic devices, such as music players, palmtop computers and the like. It should also be noted that there are many alternative ways of implementing the methods and apparatuses of the teachings of the present application.

Features described in the preceding description may be used in combinations other than the combinations explicitly described.

Whilst endeavoring in the foregoing specification to draw attention to those features of the disclosed embodiments believed to be of particular importance it should be understood that the Applicant claims protection in respect of any patentable feature or combination of features hereinbefore referred to and/or shown in the drawings whether or not particular emphasis has been placed thereon.

The term “comprising” as used in the claims does not exclude other elements or steps. The term “a” or “an” as used in the claims does not exclude a plurality. A unit or other means may fulfill the functions of several units or means recited in the claims.

1. A user interface for use with a device having a display and a controller, said display being configured to display a portion of content, said content being related to an application which application said controller is configured to execute and said content comprising an object, said controller being further configured to receive touch input and determine whether said received touch input represents a scrolling action or an object specific action according to an originating location of said touch input in relation to said content.

2. A user interface according to claim 1 wherein said object is an embedded object or a movable object.

3. A user interface according to claim 1 wherein said controller is further configured to display a false edge along at least one side of an application area being displayed on said display in response to said originating location being close to said side of said application area when said application area is filled by an object and wherein said controller is configured to determine that a touch input, either the received or a further received, is to be determined to represent a scrolling action if said touch input originates within said false edge and an object specific application if it originates within said application area and outside said false edge.

4. A user interface according to claim 3 wherein said originating location is on an edge of said side of said application area.

5. A user interface according to claim 3 wherein said originating location is outside said application area and said touch input corresponds to a sliding gesture terminating or continuing inside said application area.

6. A user interface according to claim 1 wherein said controller is further configured to upon receipt of a touch input representing a scroll action translate said content relative said application area and wherein said controller is further configured to determine whether said translation results in that said application area is filled by an object upon which said controller is configured to automatically translate said content so that said application area is not filled by said object and wherein said controller is configured to determine that received touch input comprising a sliding gesture originating within said object represents an object specific action and that that received touch input comprising a sliding gesture originating outside said object represents a scrolling action.

7. A user interface according to claim 6 wherein said controller is further configured to automatically translate said content in the direction of the scrolling action.

8. A user interface according to claim 6 wherein said controller is further configured to determine the shortest distance to an edge of said object and automatically translate said content in that direction.

9. A user interface according to claim 6 wherein said controller is further configured to execute said automatic translation simultaneous with said scroll action so that said object does not fully cover said application area once said scroll action is terminated.

10. A user interface according to claim 1 wherein said controller is configured to determine whether a previous scrolling function is still active and determine that all received touch input comprising a sliding gesture represents a further scrolling action regardless of originating location within an application area.

11. A user interface according to claim 10 wherein said controller is configured to determine said previous scrolling action to be active when a virtual momentum is greater than zero.

12. A user interface according to claim 10 wherein said controller is configured to determine said previous scrolling action to be active when a timer is running.

13. A user interface according to claim 1 wherein said controller is configured to determine:
whether said received touch input originates in an object and if so determine that the touch input represents an object specific action,
whether said received touch input originates in content adjacent an object and if so determine that the touch input represents a scrolling action, or
whether said received touch input originates both in an object and in content adjacent said object and if so determine that the touch input represents a scrolling action.

14. A user interface according to claim 13 wherein said controller is further configured to determine whether said received touch input originates both in a first object and in a second object and if so determine that the touch input represents a scrolling action.

15. A user interface according to claim 13 wherein said controller is configured to receive multi-touch input as the received touch input.

16. A user interface according to claim 1 wherein said object specific action is one taken from a group comprising: panning, rotating, zooming, and rotating.

17. A device incorporating and implementing or configured to implement a user interface according to claim 1.

18. A method for differentiating between scrolling actions and object specific actions for use in a device having a display and a controller, said display being configured to display a portion of content, said content being related to an application which application said controller is configured to execute and said content comprising an object, said method comprising receiving touch input and determining whether said received touch input represents a scrolling action or an object specific action according to an originating location of said touch input in relation to said content.

19. A method according to claim 18 wherein said object is an embedded object or a movable object.

20. A method according to claim 18 further comprising displaying a false edge along at least one side of an application area being displayed on said display in response to said originating location being close to said side of said application area when said application area is filled by an object and determining that a touch input, either the received or a further received, is to be determined to represent a scrolling action if said touch input originates within said false edge and an object specific application if it originates within said application area and outside said false edge.

21. A method according to claim 20 wherein said originating location is on an edge of said side of said application area.

22. A method according to claim 20 wherein said originating location is outside said application area and said touch input corresponds to a sliding gesture terminating or continuing inside said application area.

23. A method according to claim 18 further comprising translating said content relative said application area upon receipt of a touch input representing a scroll action,
determining whether said translation results in that said application area is filled by an object and if so automatically translating said content so that said application area is not filled by said object and
determining that said received touch input comprising a sliding gesture originating within said object represents an object specific action and that that received touch input comprising a sliding gesture originating outside said object represents a scrolling action.

24. A method according to claim 23 further comprising automatically translating said content in the direction of the scrolling action.

25. A method according to claim 23 further comprising determining the shortest distance to an edge of said object and automatically translate said content in that direction.

26. A method according to claim 23 further comprising executing said automatic translation simultaneous with said scroll action so that said object does not fully cover said application area once said scroll action is terminated.

27. A method according to claim 18 wherein further comprising determining whether a previous scrolling function is still active and
determining that all received touch input comprising a sliding gesture represents a further scrolling action regardless of originating location within an application area.

28. A method according to claim 27 determining said previous scrolling action to be active when a virtual momentum is greater than zero.

29. A method according to claim 27 further comprising determining said previous scrolling action to be active when a timer is running.

30. A method according to claim 18 further comprising determining:
whether said received touch input originates in an object and if so determining that the touch input represents an object specific action,
whether said received touch input originates in content adjacent an object and if so determining that the touch input represents a scrolling action, or
whether said received touch input originates both in an object and in content adjacent said object and if so determining that the touch input represents a scrolling action.

31. A method according to claim 30 further comprising determining whether said received touch input originates both in a first object and in a second object and if so determining that the touch input represents a scrolling action.

32. A method according to claim 30 further comprising receiving multi-touch input as the received touch input.

33. A method according to claim 18 wherein said object specific action is one taken from a group comprising: panning, rotating, zooming, and rotating.

34. A device incorporating and implementing or configured to implement a method according to claim 18.

35. A computer readable medium including at least computer program code for controlling a user interface comprising a display and a controller, said display being configured to display a portion of content, said content being related to an application which application said controller is configured to execute and said content comprising an object, said computer readable medium comprising:
software code for receiving touch input and
software code for determining whether said received touch input represents a scrolling action or an object specific action according to an originating location of said touch input in relation to said content.

36. A computer readable medium according to claim 35 further comprising software code for displaying a false edge along at least one side of an application area being displayed on said display in response to said originating location being close to said side of said application area when said application area is filled by an object and determining that a touch input, either the received or a further received, is to be determined to represent a scrolling action if said touch input originates within said false edge and an object specific application if it originates within said application area and outside said false edge.

37. A computer readable medium according to claim 35 further comprising software code for translating said content relative said application area upon receipt of a touch input representing a scroll action,
software code for determining whether said translation results in that said application area is filled by an object and if so automatically translating said content so that said application area is not filled by said object and
software code for determining that said received touch input comprising a sliding gesture originating within said object represents an object specific action and that that received touch input comprising a sliding gesture originating outside said object represents a scrolling action.

38. A computer readable medium according to claim 35 further comprising software code for determining whether a previous scrolling function is still active and
software code for determining that all received touch input comprising a sliding gesture represents a further scrolling action regardless of originating location within an application area.

39. A computer readable medium according to claim 35 further comprising software code for determining:
whether said received touch input originates in an object and if so determining that the touch input represents an object specific action,
whether said received touch input originates in content adjacent an object and if so determining that the touch input represents a scrolling action, or
whether said received touch input originates both in an object and in content adjacent said object and if so determining that the touch input represents a scrolling action.

40. A device incorporating and implementing or configured to implement a computer readable medium according to claim 35.

41. A user interface comprising display means being for displaying a portion of content, said content being related to an application which application adapted to be executed by control means and said content comprising an object, said user interface further comprising:
control means for receiving touch input and
control means for determining whether said received touch input represents a scrolling action or an object specific action according to an originating location of said touch input in relation to said content.

42. A user interface according to claim 41 further comprising control means for displaying a false edge along at least one side of an application area being displayed on said display in response to said originating location being close to said side of said application area when said application area is filled by an object and determining that a touch input, either the received or a further received, is to be determined to represent a scrolling action if said touch input originates within said false edge and an object specific application if it originates within said application area and outside said false edge.

43. A user interface according to claim 41 further comprising control means for translating said content relative said application area upon receipt of a touch input representing a scroll action,
control means for determining whether said translation results in that said application area is filled by an object and if so automatically translating said content so that said application area is not filled by said object and
control means for determining that said received touch input comprising a sliding gesture originating within said object represents an object specific action and that that received touch input comprising a sliding gesture originating outside said object represents a scrolling action.

44. A user interface according to claim 41 further comprising control means for determining whether a previous scrolling function is still active and
control means for determining that all received touch input comprising a sliding gesture represents a further scrolling action regardless of originating location within an application area.

45. A user interface according to claim 41 further comprising control means for determining:
whether said received touch input originates in an object and if so determining that the touch input represents an object specific action,
whether said received touch input originates in content adjacent an object and if so determining that the touch input represents a scrolling action, or
whether said received touch input originates both in an object and in content adjacent said object and if so determining that the touch input represents a scrolling action.

46. A device incorporating and implementing or configured to implement user interface according to claim 41.
